(19) United States
(12) Patent Application Publication
(10) Pub. No.: US 2015/0317718 A1
(43) Pub. Date: Nov. 5, 2015

(54) Defining a Selection Process

(71) Applicant: Attraqt Limited, London (GB)

(72) Inventor: André Brown, London (GB)

(21) Appl. No.: 14/700,827

(22) Filed: Apr. 30, 2015

(30) Foreign Application Priority Data
Apr. 30, 2014 (GB) 1407598.0

(51) Int. Cl. G06Q 30/06

(52) U.S. Cl. CPC G06Q 30/0631; G06Q 30/0643

(57) ABSTRACT

A selection process is defined for items provided by an e-commerce site to shoppers' web browsers. One or more selection attributes are identified for each e-commerce shop item. A selection function is defined in association with each selected attribute. At least one rule is defined for combining one or many of selection scores from respective selection functions to obtain an item score. The selection process is then defined as selecting items in response to the item scores.

### CROSS REFERENCE TO RELATED APPLICATIONS

This application claims priority from United Kingdom Patent Application No. 14 07 598.0, filed Apr. 30, 2014, the entire disclosure of which is incorporated herein by reference in its entirety.

### BACKGROUND OF THE INVENTION

1. Field of the Invention

The present invention relates to defining a selection process for displaying items on a customer's web browser when the customer is shopping online.

2. Description of the Related Art

It is known that e-commerce facilitates provide access to extensive markets for retailers and producers of diverse goods. This is sometimes called the long tail, which describes the ability for vendors with highly specialised goods to economically connect with customers that otherwise would be unavailable. At the other end of the scale, enormous volumes of sales are driven by economies due to automated warehousing, just-in-time stock replenishment, and so on.

However, there are also some disadvantages to e-commerce as compared to traditional stores which customers visit in person. In particular, the interaction between customers and staff can be extremely subtle, and a great deal of specialised knowledge may be built up over many years, both in terms of individual staff members, and the culture and collective knowledge embodied in the practices of their trade. These skills cannot easily be applied to online sales.

In e-commerce, goods are usually displayed on a customer's web browser in response to results from a category search or recommendations engine. This is completely unlike the way a shop assistant would respond to a customer or construct a display of goods, in which years of experience result in an intuition that may be difficult to quantify. A shop assistant's intuition can be highly effective, both to the benefit of the store and in terms of meeting customers' needs. However, the advantages of e-commerce are usually so great, that they tend to outweigh traditional skills and salesmanship, even though the two are completely different.

Traditional skills and knowledge, if they could be applied in an e-commerce context, would represent a theoretical advance over the art. Ideally, the considerable advantages of e-commerce would be combined with traditional skills and experience acquired over many years. While such an idea sounds appealing, its application in practice is far from trivial. One approach is to apply artificial intelligence algorithms to learn from online experience in the same way that a shop assistant learns from customer interactions. Such methods are in their infancy, and extremely complex to implement and control. Therefore, there are known theoretical solutions to combining e-commerce with the flexibility and intuition of traditional salesmanship, but these are currently impractical.

### BRIEF SUMMARY OF THE INVENTION

According to an aspect of the present invention, there is provided a method of defining a selection process for items provided by an e-commerce site to shoppers' web browsers, comprising the steps of; identifying one or more selection attributes for each said e-commerce shop item; defining a selection function in association with each said selection attribute; defining at least one rule for combining one or a plurality of selection scores from respective said selection functions to obtain an item score; and defining the selection process as selecting items in response to said item scores.

In an embodiment, the step of defining at least one rule further includes defining at least one trigger for each said rule, to the effect that a rule will only be applied when its trigger conditions are met.

According to a second aspect of the present invention, there is provided a method of selecting items to be provided by an e-commerce site for display on shoppers' web browsers, comprising steps applied to candidate items of: identifying one or more selection attribute for each said candidate item; evaluating a selection function associated with each said selection attribute to obtain a selection score; applying a rule for combining a plurality of selection scores to obtain an item score for each respective item; and selecting preferred items in response to said item scores.

In an embodiment, the selection process includes validating at least one of a plurality of rules in a prioritised list of rules, until a rule is identified as meeting one or more requirements of its applicability.

According to a third aspect of the present invention, there is provided a method of defining a selection process for items provided by an e-commerce site to shoppers' web browsers, comprising steps performed on a graphical user interface of identifying one or more selection attributes for said e-commerce shop items; defining a selection function in association with each said selection attributes; defining at least one rule for combining selection scores from respective said selection functions to obtain an item score.

### BRIEF DESCRIPTION OF THE DRAWINGS

FIG. 1 shows an e-commerce environment, including customer web browsers, e-commerce sites, supplier sites and supplier web browsers, and a data processor;

FIG. 2 details the data processor shown in FIG. 1, including a web server;

FIG. 3 details the steps performed when starting up and running the data processor shown in FIG. 2 during e-commerce operations, including a step of running web servers;

FIG. 4 details the components of a web server of the kind shown in FIG. 2, including memory;

FIG. 5 details the contents of the memory shown in FIG. 4, including item priority definitions and rules;

FIG. 6 details an item priority definition of the kind shown in FIG. 5, including a number of selection functions;

FIG. 7 details the step of running web servers shown in FIG. 3, including a step of priority update processing and a step of generating a prioritized list;

FIG. 8 details the step of priority update processing shown in FIG. 7, including a step of analysing data;

FIG. 9 illustrates a graphical user interface displayed on the supplier web browser shown in FIG. 1, when defining a first type of selection function of the kind shown in FIG. 6;

FIG. 10 illustrates numerical properties of the selection function defined in FIG. 9;

FIG. 11 illustrates a graphical user interface displayed on the supplier web browser shown in FIG. 1, when defining a second type of selection function of the kind shown in FIG. 6;

FIG. 12 illustrates numerical properties of the selection function defined in FIG. 11;

FIG. 13 illustrates a graphical user interface displayed on the supplier web browser shown in FIG. 1, when defining a third type of selection function of the kind shown in FIG. 6;

FIG. 14 illustrates numerical properties of the selection function defined in FIG. 13;

FIG. 15 illustrates a graphical user interface displayed on the supplier web browser shown in FIG. 1, when defining a fourth type of selection function of the kind shown in FIG. 6;

FIG. 16 illustrates numerical properties of the selection function defined in FIG. 15;

FIG. 17 illustrates a graphical user interface displayed on the supplier web browser shown in FIG. 1, when defining a fifth type of selection function of the kind shown in FIG. 6;

FIG. 18 illustrates numerical properties of the selection function defined in FIG. 17;

FIG. 19 illustrates a graphical user interface displayed on the supplier web browser shown in FIG. 1, when defining a sixth selection function of the kind shown in FIG. 6;

FIG. 20 illustrates numerical properties of the selection function defined in FIG. 19;

FIG. 21 illustrates a graphical user interface displayed on the supplier web browser shown in FIG. 1, when defining a rule of the kind shown in FIG. 5;

FIG. 22 illustrates numerical properties of the rule defined in FIG. 21;

FIG. 23 details the step of analysing data shown in FIG. 8;

FIG. 24 illustrates the effect of the process detailed in FIG. 23;

FIG. 25 details a further embodiment of the step of analysing data shown in FIG. 8;

FIG. 26 illustrates the effect of the process detailed in FIG. 25;

FIG. 27 details the step of generating a prioritized list shown in FIG. 7; and

FIG. 28 illustrates the display shown on a customer web browser of the kind shown in FIG. 1.

### DETAILED DESCRIPTION OF EXAMPLE EMBODIMENTS

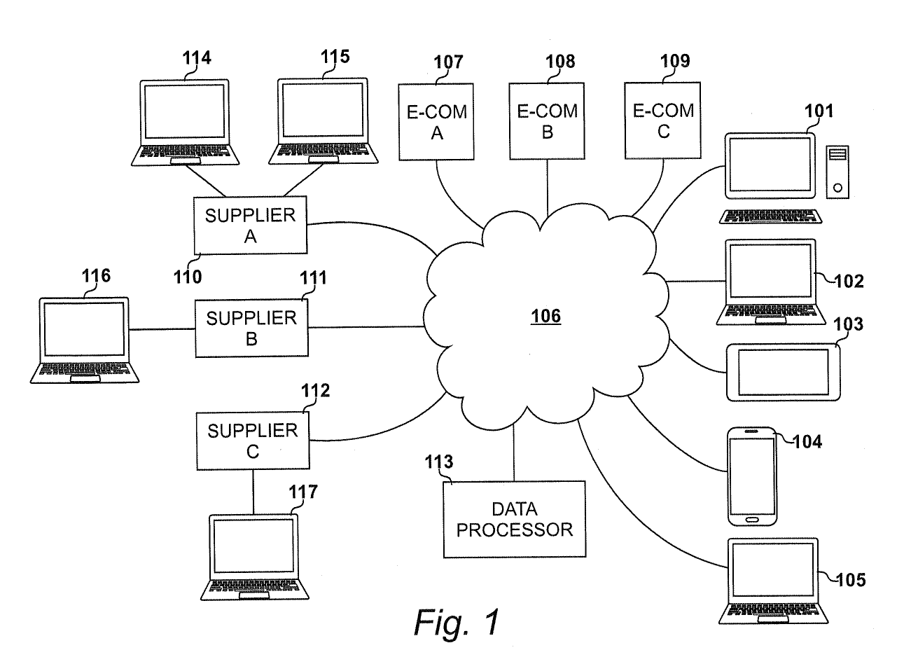

### FIG. 1

An e-commerce environment is illustrated in FIG. 1. E-commerce items are displayed to customers having web browsing devices 101 to 105, including a desktop computer 101, a laptop computer 102, a tablet computer 103, a smartphone 104 and a laptop computer 105. Each web browsing device is connected to the Internet 106, to which are connected three e-commerce sites 107 to 109. The e-commerce sites 107 to 109 are responsible for facilitating online shopping, including displaying images of items which are available for purchase on the customer's web browser, receiving a customer payment, and arranging delivery of physical goods to a customer's address. The e-commerce sites 107 to 109 communicate with suppliers 110 to 112, which supply items to customers in response to a confirmed sale. Each e-commerce site may have a different area of specialisation. For example, e-commerce site 107 may specialise in clothing, whereas e-commerce site 108 may specialise in cars. Furthermore, some sites, such as site 108, may combine many areas of specialisation, providing a unified online shopping facility for many different categories of goods.

The suppliers 110 to 112 may similarly have particular expertise or provide general capabilities for a wide variety of goods. However, it is recognised that traditional sales expertise involves a detailed knowledge of particular types of goods, and in order to facilitate high quality supply, generally a supplier 110, 111 or 112 will have some particular expertise in specific types of goods. In order to make use of this expert knowledge, a data processor 113 is included in the e-commerce environment of FIG. 1. Expert knowledge is supplied at computers 114 and 115 attached to supplier A's internal network, or by computers 116 and 117 attached to the internal networks of suppliers B and C 111 and 112 respectively. Expert knowledge is used by the data processor 113 in combination with e-commerce sites 107 to 109, to populate web pages on customer's browsers 101 to 105. For the purposes of simplicity, web browser software and the web browsing device on which it runs, will be referred to hereinafter simply as a web browser.

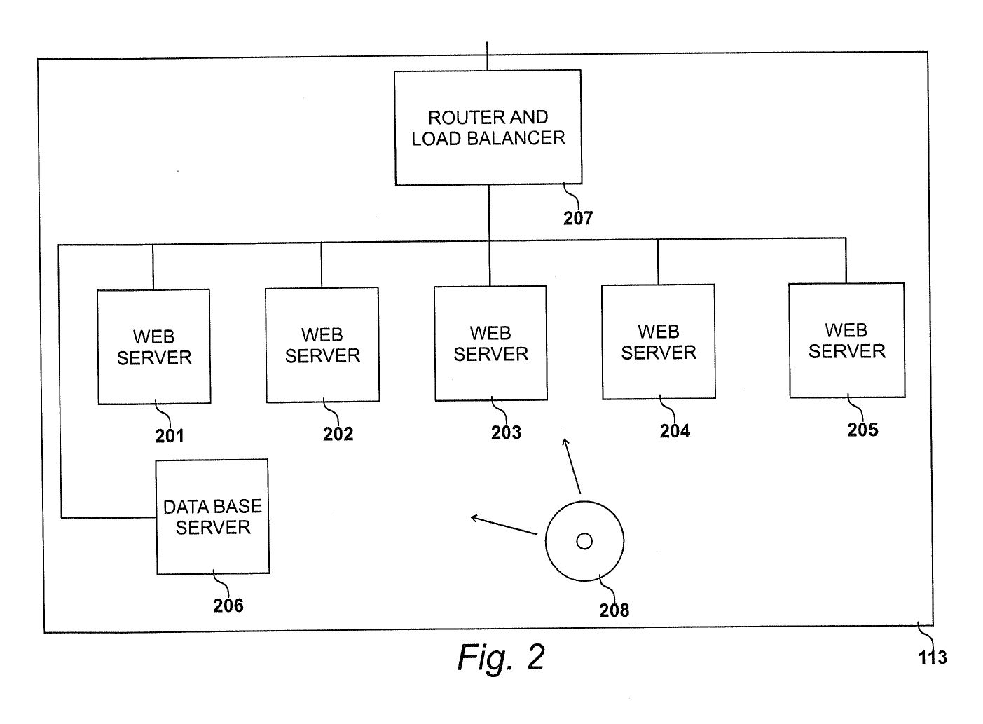

### FIG. 2

The data processor 113 shown in FIG. 1 is detailed in FIG. 2. A number of web servers 201 to 205 receive web requests from the Internet 106. The web servers also communicate with a database server 206, which contains databases for items supplied by suppliers 110 to 112, including a search database and a recommendations database. The web servers 201 to 205 connect with the Internet 106 via a router and load-balancer 207. Each web server 201 to 205 performs substantially the same functions, and the router and load balancer 206 determine how large numbers of requests are distributed to the servers 201 to 205 in a way that maximises their speed. When responding to an incoming request, each web server 201 to 205 accesses its own internal cache of the items stored on the database server 206. If an item is not present in its cache, the web server will make a request for that item from the database server. Conversely, when writing to its internal cache, the same data will be marked as out of date on the database server 206, and updated after a short delay. The operations of an individual webserver 201 or 202 will therefore be described as a functional model for the entire data processor 113, although the operations of load balancing and database caching are necessary to achieve this effect, as will be understood by those skilled in the art.

In an embodiment, instructions for the processor systems of the servers 201 to 206 and router and load-balancer 207 are installed from a CDROM 208 on one of the processor systems 207, and then distributed by network installation to the remainder of the data processor components 201 to 206. The data processor 113 provides an optimal configuration for serving components of web pages delivered to customers browsers 101 to 105, in response to browsing of e-commerce sites 107 to 109, and operations of the data processor 113 include receiving expert data supplied from one or more of the suppliers 110 via computers 114 to 117.

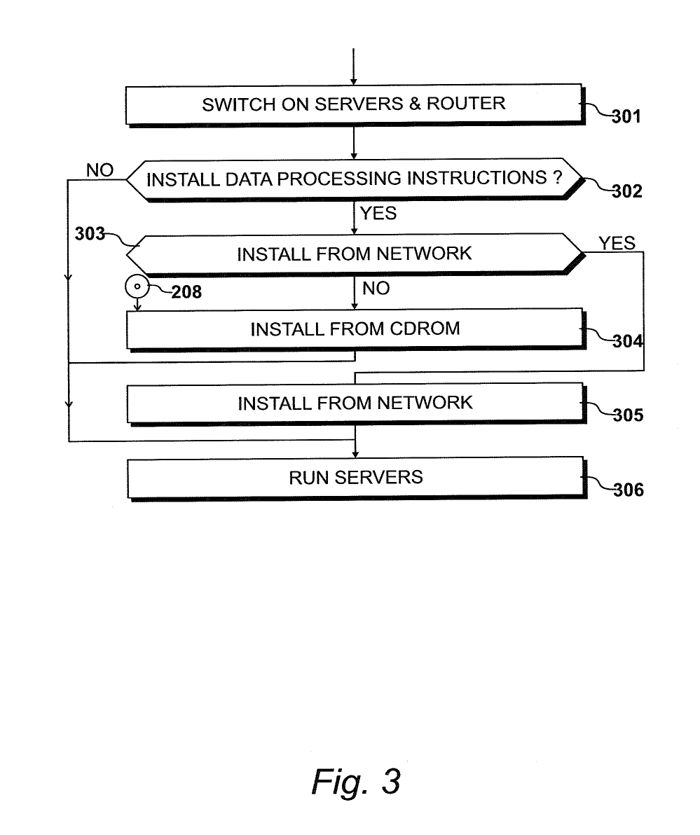

### FIG. 3

The steps for operating the data processor 113 shown in FIG. 2 are illustrated in FIG. 3. At step 301 the servers 201 to 205 and 207 and router and load balancer 206 are switched on. At step 302, a question is asked as to whether installation is required. If so, a further question is asked at step 303 as to whether installation from a network is required. If not, installation from a CDROM 208 is performed at step 304. Alternatively network installation is performed at step 305. At step 306, it is known that data processor instructions are now installed, and these instructions are run on the servers 201 to 205 and other components of the data processor 113.

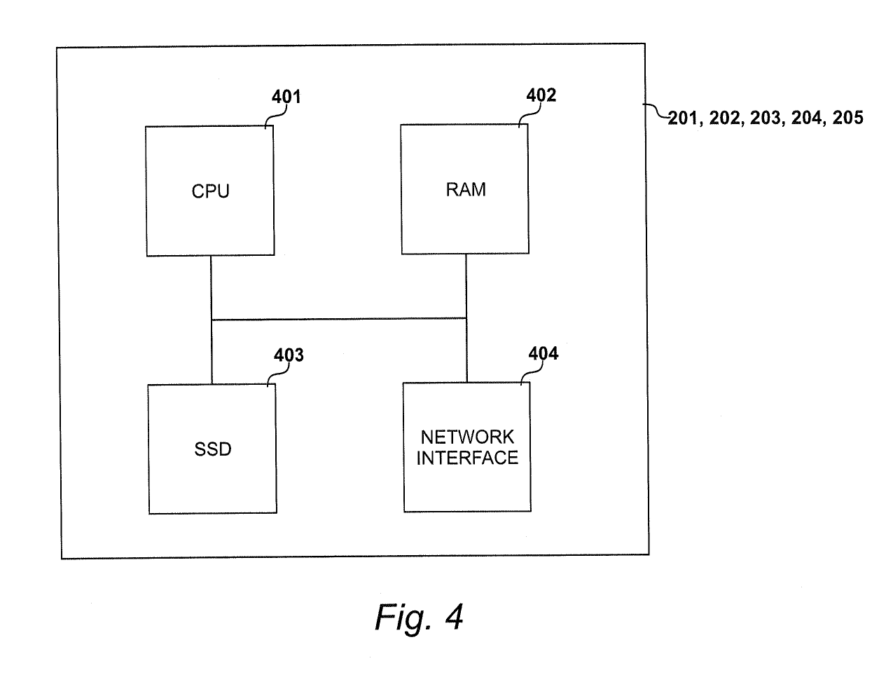

### FIG. 4

For the purposes of the present description, reference will be made to the components of one of the web servers 201 of the data processor 113, which, by virtue of load balancing and database caching, will serve as a description for the operations of the data processor 113 as a whole. The web server 201 includes an Intel™ E7-8830 central processing unit (CPU) 401, comprising eight processor cores arranged in a symmetrical multi-processing (SMP) configuration. Each core has instruction and data caches, and a higher level combined data and instruction cache IS shared by the eight cores.

The CPU 401 connects to sixty-four gigabytes of read-and-write memory (RAM), which holds instructions and data. Instructions and data are also stored in a non-volatile solid-state drive (SSD) 403, from which the server can boot after power on, if instructions have already been installed. A network interface 404 connects the web server 201 to the database server 206 and the Internet 106 via the router and load-balancer 207.

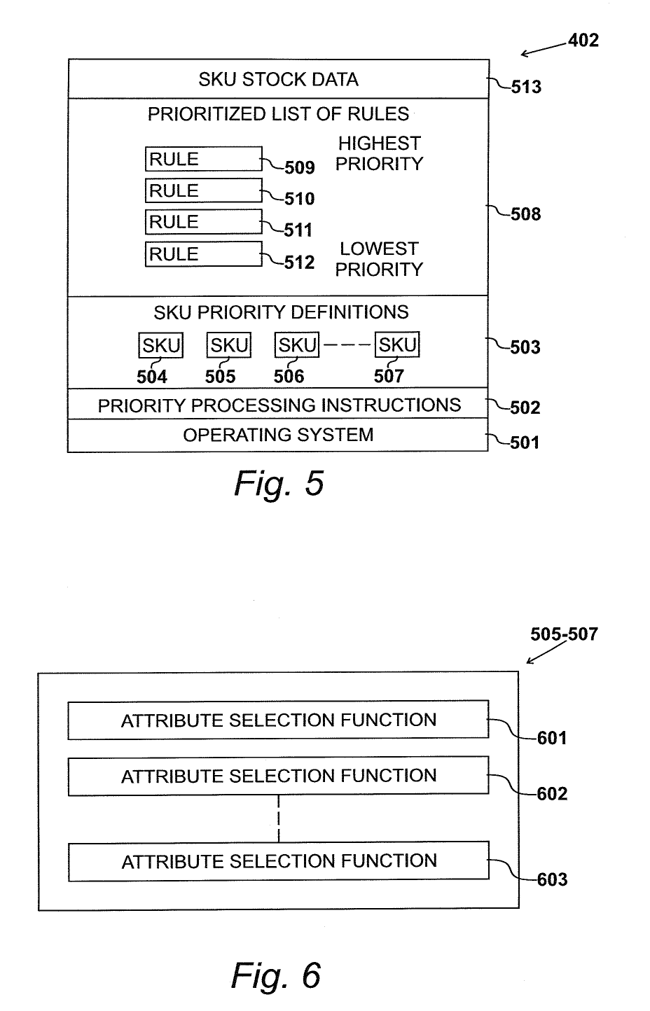

### FIG. 5

The contents of RAM 402 shown in FIG. 4 are detailed in FIG. 5, while performing data processing at step 306 of FIG. 3. Operating system instructions 501 provide hardware device abstraction, multitasking and common functionality for other processing instructions. Priority processing instructions 502 include customised web serving instructions for the purpose of delivering prioritised item displays on customer browsers 101 to 105 in response to their online e-commerce shopping activity. Each distinct type of item provided by a supplier 110 to 112 has a Stock Keeping Unit (SKU), which is stored in the form of a code number and data associated with this code number. A database cache of SKU priority definitions is stored in RAM at 503, including SKU priority definitions 504 to 507. Typically, there are several hundred SKUs, each with their own priority definition. A prioritized list of rules 508 includes a highest priority rule 509, and lower priority rules 510 to 512, listed in order of preference. Each rule may refer to one or several of the selection functions 504 to 507. Each SKU also has associated stock data, and a database cache of stock data is held in RAM at 513, so that the number of items available will be known to the web server processor 401. Database caches 503, 508 and 513 are copies of recently-used data sent to or obtained from the database server 206. For the purposes of clarity in the present description, the caching process will not be detailed.

### FIG. 6

An SKU priority definition of the type indicated at 504, 505, 506 and 507 in FIG. 5 is detailed in FIG. 6. Each SKU's priority definition comprises one or a plurality of attribute selection functions 601 to 603.

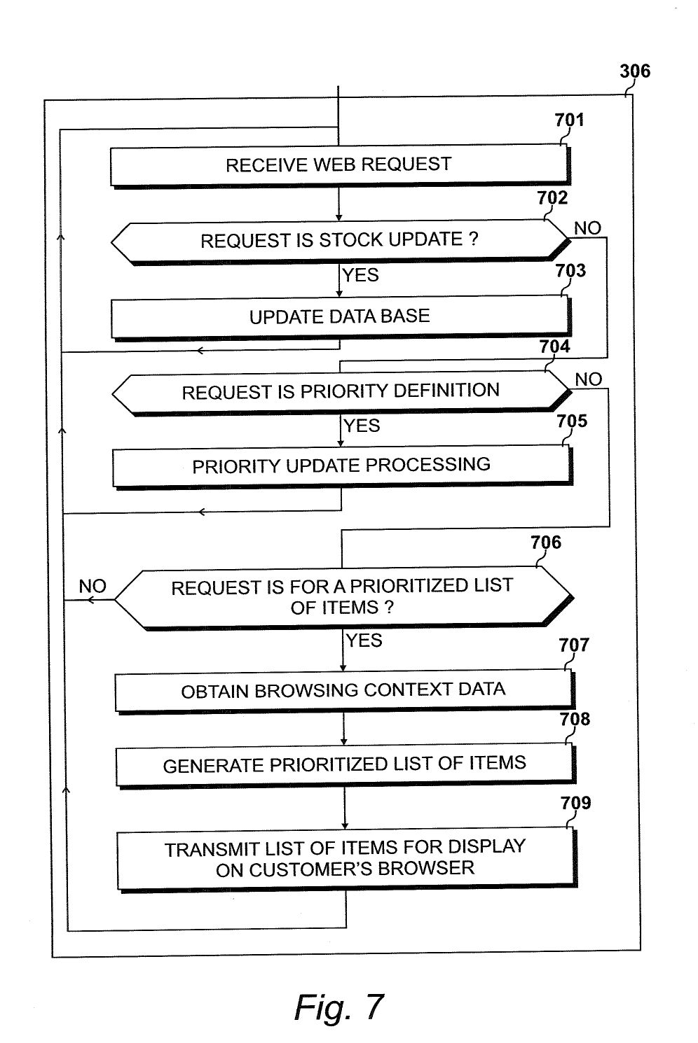

### FIG. 7

The step 306 of running servers, shown in FIG. 3, is detailed in FIG. 7. At step 701 a web server, such as server 201, receives a web request. At step 702, a question is asked as to whether the request is a stock update. If so, the cache of SKU stock data 513 is updated, along with an automatic update of the database server 206, and control is directed back to step 701. Alternatively, at step 704 a question is asked as to whether the web request is a priority definition. If so, priority update processing is performed at step 705. Alternatively, at step 706, a question is asked as to whether the web request is for a prioritised list of items. If not, control is directed back to step 701. Alternatively, browsing context data is obtained from a customer's browser 101 at step 707. At step 708 a prioritised list if items is generated. At step 709 the list of items is transmitted back to the customer's browser 101.

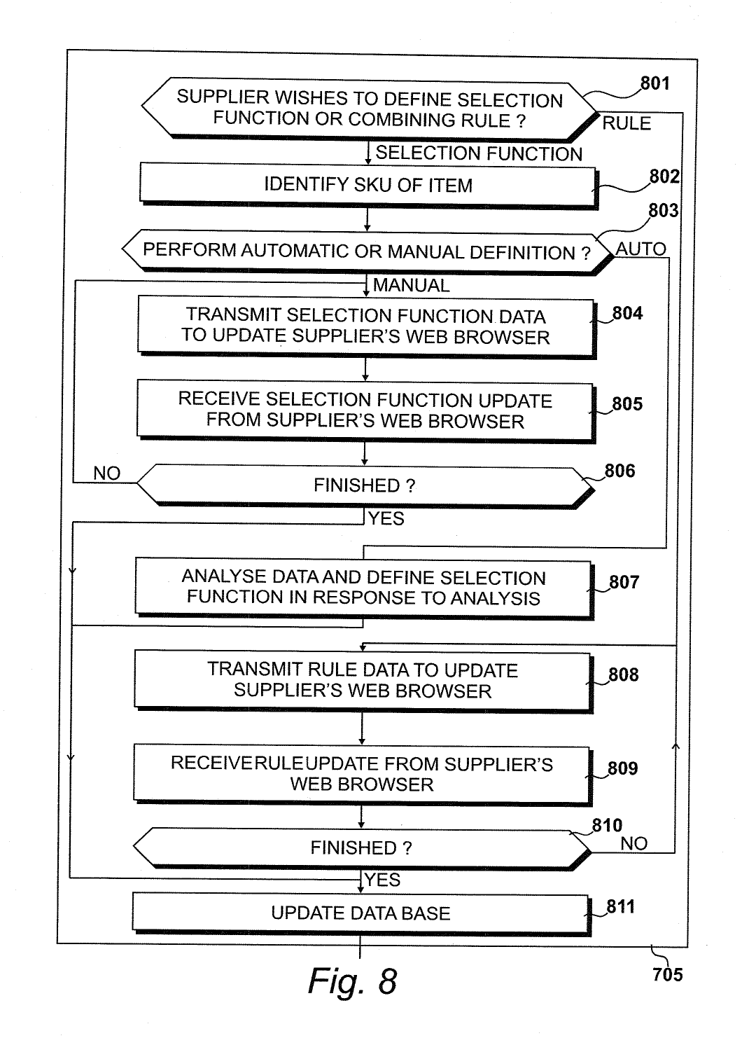

### FIG. 8

Step 705 of performing priority update processing, shown in FIG. 7, is detailed in FIG. 8. At the start of these steps, it is known that the web request has come from a web browsing computer, such as browser 114, connected to one of the suppliers 110 to 112, such as supplier 110. It is further known that the operator of the browser 114 wishes to define a selection process. At step 801, a question is asked as to whether the supplier wishes to define a selection function of a combining rule. Steps 802 to 806 or step 807 are performed for a selection function and steps 808 to 810 are performed for a combining rule. At step 802 an identification is made of the SKU of the item whose selection process is to be defined in response to operator interaction with the browser 114.

At step 803, a question is asked as to whether an automatic or manual definition of the selection function should be made. For manual definition, steps 804 to 806 are performed. At step 804 existing selection function data is transmitted to the supplier's web browser 114 to update a graphical user interface. At step 805 a selection function update is received from the browser 114, and this is used to modify, add or delete one of the attribute selection functions 601 shown in FIG. 6. At step 806 a question is asked as to whether the operator of the browser 114 has finished defining the selection function. If not, control is directed back to step 804 and further updates are made. Alternatively, once finished, control is directed to step 811, where the SKU priority definition is updated in the database server 206. At step 807, data is analysed to define a selection function 602, 603 or 604 automatically.

At step 808, rule data 606, 607 or 608 is transmitted to update the display on the supplier's web browser 114. At step 809 rule updates are received from the supplier's web browser 114. At step 810 a question is asked as to whether the operator of the browser 114 has finished defining the rule. If not, control is directed back to step 808 and further updates are made. Alternatively, once finished, control is directed to step 811, where the SKU priority definition is updated in the database server 206.

The result of the steps shown in FIG. 8 is that a person with specialist knowledge of selling goods has defined data structures which will beneficially affect the interaction of a customer with an e-commerce site.

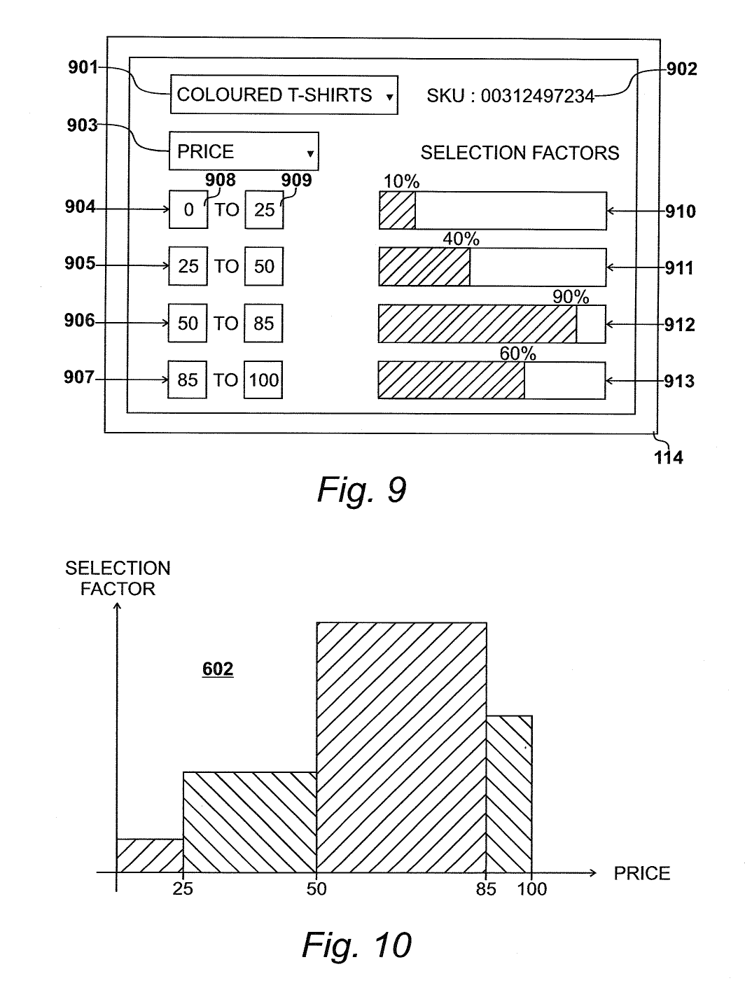

### FIG. 9

A user interface displayed on the supplier's computer 114 shown in FIG. 1, when interacting with steps 804 to 806 shown in FIG. 8, is detailed in FIG. 9. The supplier 110 specialises in clothes, and the type of item is selected by a drop-down menu box 901, resulting in display of an associated SKU code 902. An attribute drop-down menu box selects from various attributes for the SKU, including price, colour, size, stock, sales, and so on. The price attribute is considered as taking an arbitrary value, and various items, depending on colour and size, have different prices.

The price can be split up into arbitrary ranges of size. In this case, the expert user performing the definition has decided, based upon their experience, to split the price into four unequal ranges 904 to 907, each defined by a minimum 908 and a maximum 909. Each of these ranges has a respective selection factor slider 910 to 913, which can be arbitrarily varied between zero and one hundred percent.

During subsequent processing, the selection factors are normalised, so that they sum to unity. In FIG. 9, the expert user has decided that shirts priced between fifty and eighty-five dollars should have the highest priority for sales, at ninety percent, compared to factors of ten, forty and sixty percent for the other price ranges. This type of prioritisation is clearly the result of experience and understanding, bringing much added value to e-commerce sites. The contents of the display shown in FIG. 9 define a selection function 602 for an attribute 903 of a particular type of item 901, identified by its SKU 902.

### FIG. 10

The selection function 602 defined in FIG. 9 is shown as a histogram in FIG. 10, in order to highlight the way in which expert knowledge is transferred and encoded into the data structures 503 of the data processor 113. Shown are the varying widths as well as heights of the price range. Varying widths are characteristic of the continuous type of selection attribute, such as price, stock, and so on, which take arbitrary numerical ranges. By contrast, an attribute like colour can take only predetermined values, like red or blue, and is considered a discontinuous attribute.

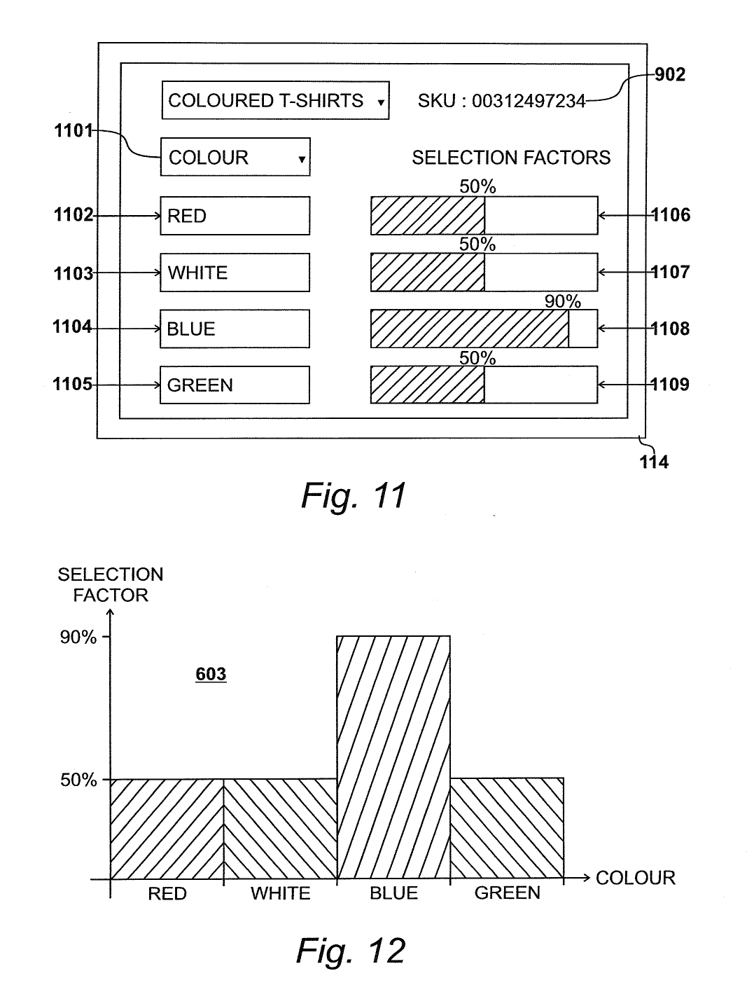

### FIG. 11

An example of an interface for the selection function of a discontinuous attribute is shown in FIG. 11. In this case, the selection attribute is a shirt's colour 1101, which takes possible values of red 1102, white 1103, blue 1104 and green 1105. Corresponding selection factors of fifty 1106, fifty 1107, ninety 1108 and fifty percent 1109 are shown. This gives a high priority to the colour blue. Again, this set of priorities is based on the experience of the person setting the selection factors, encoding their experience in such a way that an e-commerce site can benefit from it, using a user-friendly graphical user interface.

### FIG. 12

The selection function 603 defined by the interface shown in FIG. 11 is shown as a histogram in FIG. 12. Clearly shown are the fixed widths of the predetermined colour values. The histogram is non-monotonic, and may have an arbitrary shape for any number of predetermined colours. This can encompass a great deal of expert knowledge, defined using the interface of FIG. 11.

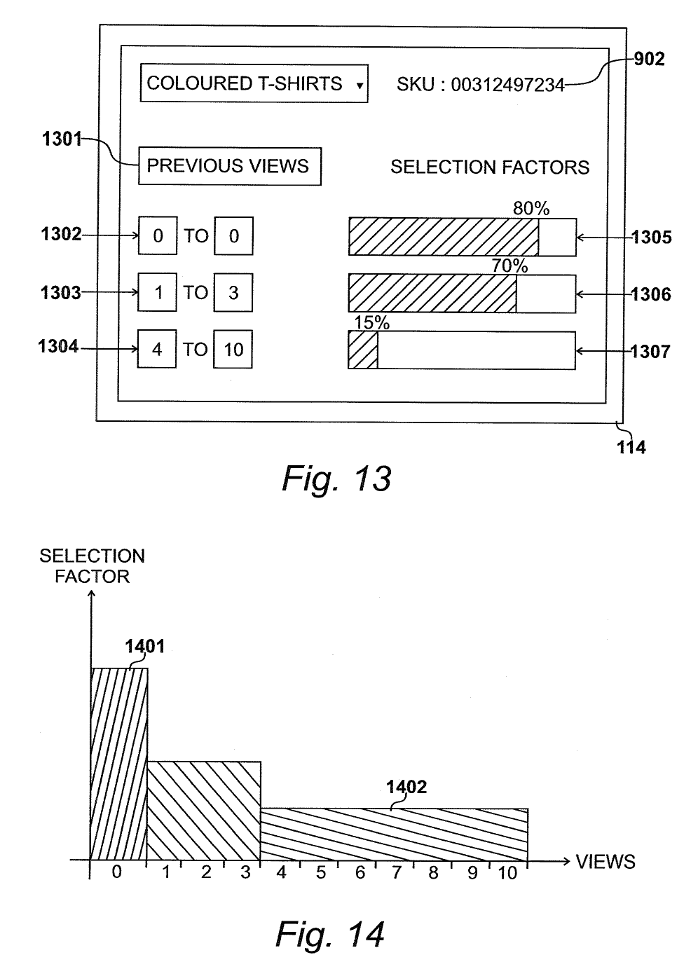

### FIG. 13

In FIG. 7 at step 707, browsing context data is obtained from a customer's browser 101. This includes a view count for each item the customer has viewed during their current browsing session at an e-commerce site. View count is one of the kinds of data stored as tracking history, and which can be retrieved, with the customer's implicit permission, by a web server in the data processor 113. As a result of the availability of this data, it can be used as an attribute in the same way as shirt size, colour, price and so on.

The number of previous views of an item may be helpful to know, and a selection function for this attribute is shown in FIG. 13. The number of previous views of the item is selected at 1301 as an attribute in the attribute drop-down menu. The expert has decided to define three different sized ranges at 1302, 1303 and 1304, and has given them selection factors of eighty percent 1305, seventy percent 1306 and fifteen percent 1307.

### FIG. 14

The result of input using the graphical user interface shown in FIG. 13 is a selection function shown as a histogram in FIG. 14. This shows how a high priority is given to the item if it hasn't been viewed yet. If the item has been viewed many times 1402, the expert has decided there's no need to repeatedly show this item to the customer if they haven't already decided to buy it.

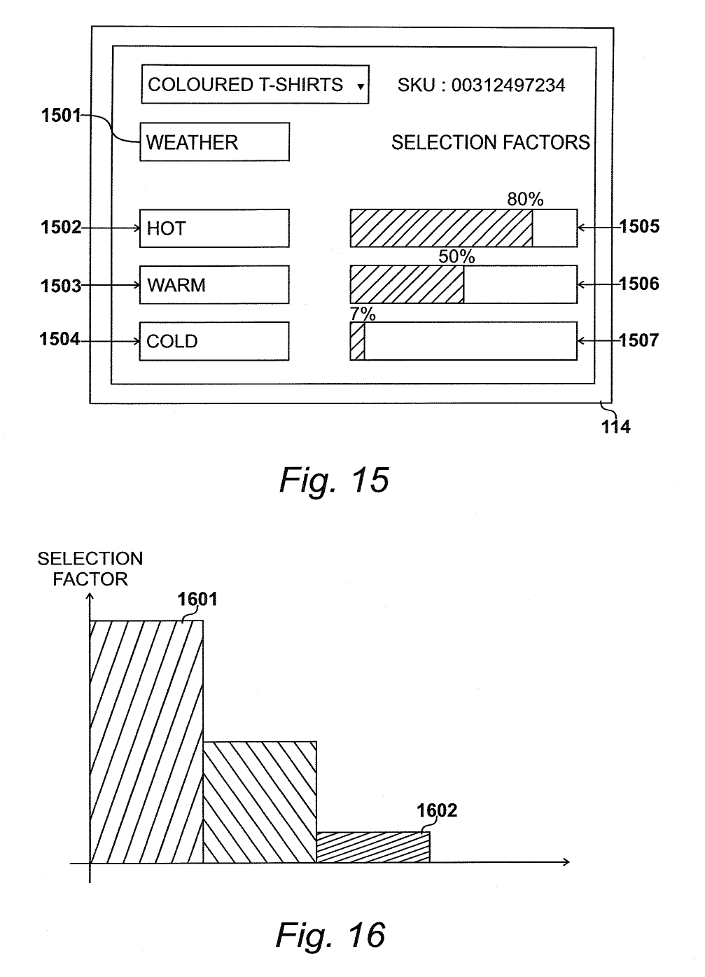

### FIG. 15

Publicly available data may be used as an attribute. Such data includes weather data, which is readily obtainable from sites on the Internet, and therefore accessible to the data processor 113. As a result of the availability of this data, it can be used as an attribute, and a selection function for a weather attribute is shown in FIG. 15. The weather is selected at 1501 as an attribute in the attribute drop-down menu. This particular form of weather attribute has just three possible values, hot 1502, warm 1503 and cold 1504. These have been given respective selection factors of eighty percent 1505, fifty percent 1506 and seven percent 1507.

### FIG. 16

The result of input using the graphical user interface shown in FIG. 15 is a selection function shown as a histogram in FIG. 16. A high priority 1601 is given to T-shirt sales in hot weather, and a relatively low priority 1602 during cold weather.

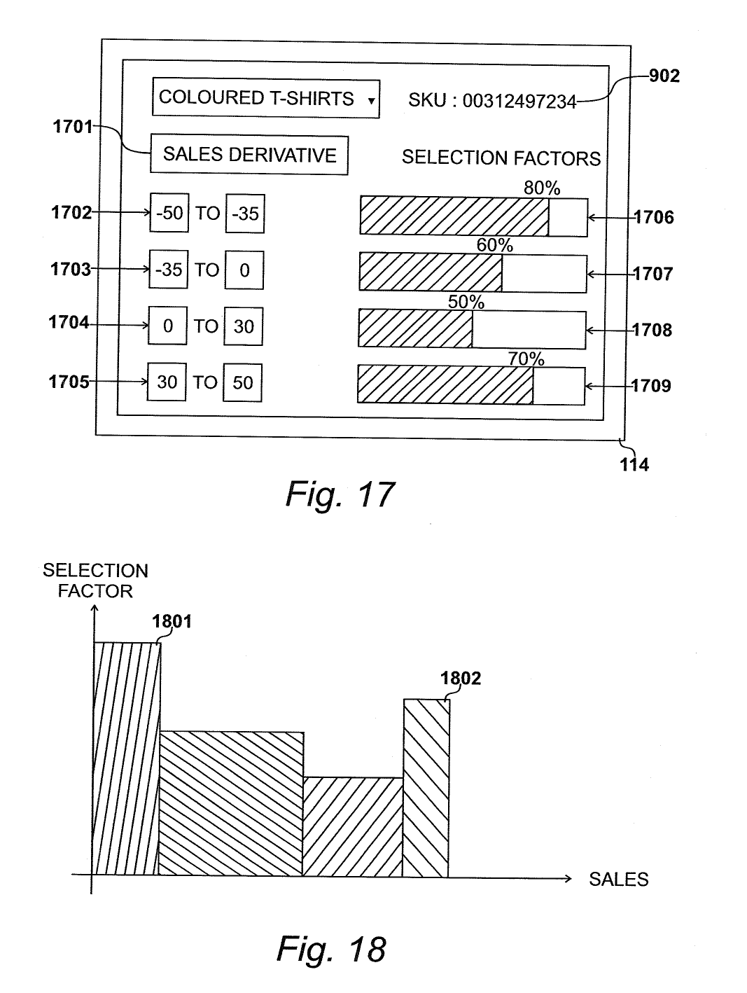

### FIG. 17

An analysis of historic sales data may be used as an attribute. In FIG. 17 a selection function for the derivative of sales with respect to days is selected at 1701 as an attribute in the attribute drop-down menu. Four different sized ranges are defined at 1702, 1703, 1704 and 1705, and these have been given selection factors of eighty percent 1706, sixty percent 1707, fifty percent 1708 and seventy percent 1709 in this example.

### FIG. 18

The result of input using the graphical user interface shown in FIG. 17 is a selection function 604 shown as a histogram in FIG. 18. This shows how a slightly higher priority 1801, 1802 is given to the item if it is on a marked upward or downward trend.

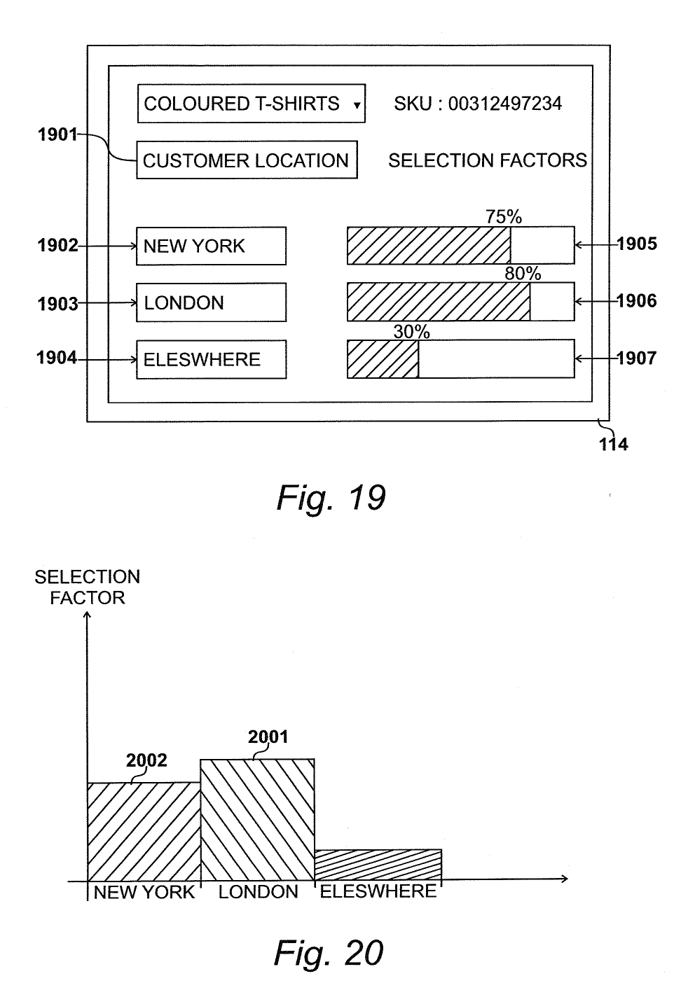

### FIG. 19

A further type of attribute is geographical location of the customer, which may be available from browsing context data obtained at step 707 in FIG. 7. FIG. 19 shows the geographical location attribute selected at 1901 in the attribute drop-down menu. Three specific values are defined as New York 1902, London 1903 and elsewhere 1904. These have been given selection factors of seventy-five percent 1905, eighty percent 1906 and thirty percent 1907.

### FIG. 20

The result of input using the graphical user interface shown in FIG. 19 is a selection function shown as a histogram in FIG. 20. This shows how a higher priority is given to T-shirts if the customer is located in London 2001 or New York 2002.

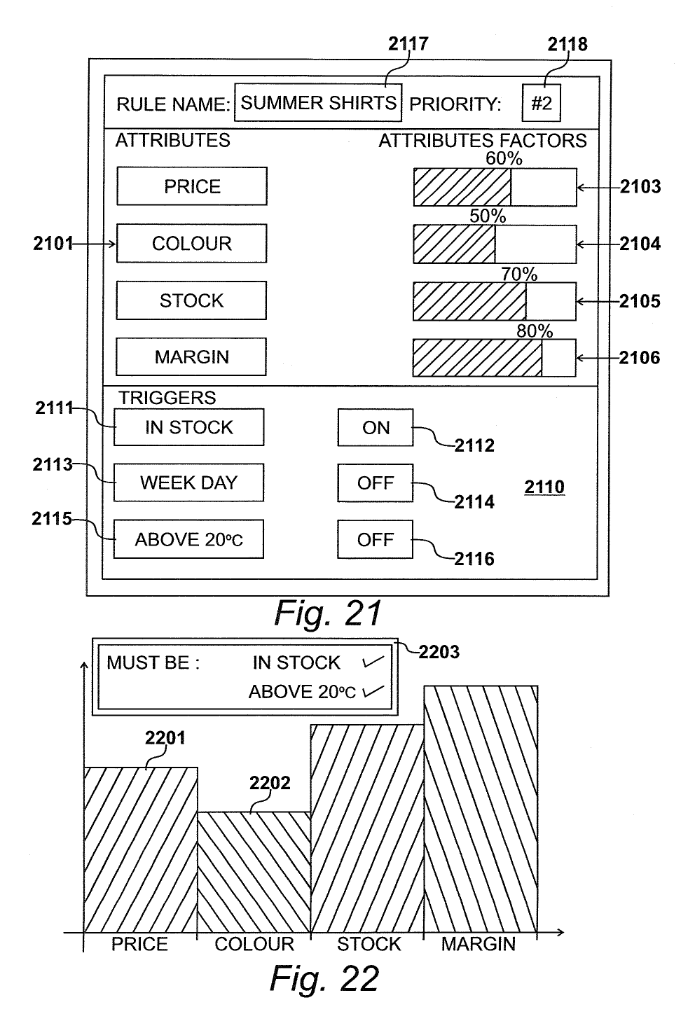

### FIG. 21

The selection function definition performed at step 805 in FIG. 8 results in the update of selection function data structures 601 shown in FIG. 6, and which are illustrated in histogram form in FIGS. 10, 12, 14, 16, 18 and 20. Selection functions are combined in varying proportions to determine the priority of a SKU. This is known as a combining rule, or simply a rule. Rule data structures are shown at 508 in FIG. 5. In the simplest case, only one selection function is defined in a rule. However, in most cases, multiple selection functions are combined.

The user interface for defining a rule as performed at steps 808 and 809 in FIG. 8, is illustrated in FIG. 21. A list of attributes 2101 includes attributes for which selection functions have been previously defined for each SKU. For example, selection functions for the price attribute 2102 are given an attribute factor of sixty percent 2103. Selection functions for the colour attribute 2104, as defined in FIGS. 11 and 12, are given an attribute factor of fifty percent 2105. The selection functions for a stock level attribute 2106 are given an attribute factor of seventy percent 2107, and the selection functions for a profit margin attribute 2108 are given an attribute factor of eighty percent 2109. This defines the way in which selection function scores will be combined. In addition to attribute factors, each rule has a set of triggers 2110. In FIG. 21 two of three visible triggers have been set for the rule. A first trigger 2111 determines whether items are in stock, and is switched on using a virtual button 2112. A second trigger 2113 determines whether the current day is a weekday, and is shown as being switched off using its associated virtual button 2114. A third trigger 2115 determines whether the air temperature of the customer's location is above twenty degrees Celsius, and is switched on according to its associated virtual button 2116. The activated trigger conditions 2111 and 2115 must be met in order for the rule to be applicable. Although three are shown, there are many others that may be activated, but which have been omitted for the sake of clarity.

### FIG. 22

The result of updates to the user interface shown in FIG. 21 are reflected in the histogram shown in FIG. 22. This is a representation of the numerical data stored in one of the rules 509 shown in FIG. 5. Other rules 510 to 512 have similar structures but with possibly different attributes and triggers. The price 2201 and colour 2202 histogram components refer to the contributions made by selection functions such as those illustrated in FIGS. 10 and 12 respectively. The triggers 2203 for stock level and temperature must be met for their rule to be applicable when prioritising items.

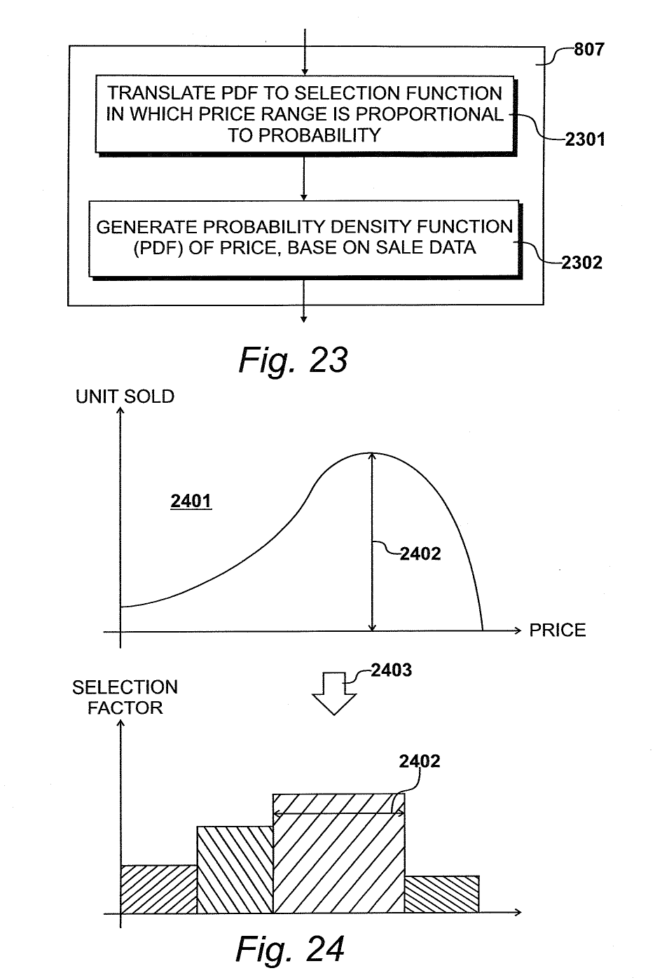

### FIG. 23

The definition of rules and selection functions as described enables an expert to transfer their knowledge to an automated item selection system. However, this can be a time consuming process when large numbers of selection functions are defined, which are preferably subject to gradual refinement over time. Therefore, in order to quickly establish a working priority system which nevertheless improves over known systems, one or more selection functions can be defined automatically.

Step 807 of analysing data and generating a selection function, shown in FIG. 8, is detailed in FIG. 23; showing the example of an analysis of sales data. At step 2301 a probability density function (PDF) is generated which represents the number of sales for each of a range of prices. At step 2302 the PDF is translated to a selection function, by setting the price range for each selection factor in accordance with its probability.

### FIG. 24

Steps of FIG. 23 are illustrated graphically in FIG. 24. The probability density function is shown at 2401, having a peak probability 2402. The PDF is translated 2403 into a small number of selection factors, whose price range is determined by an associated probability.

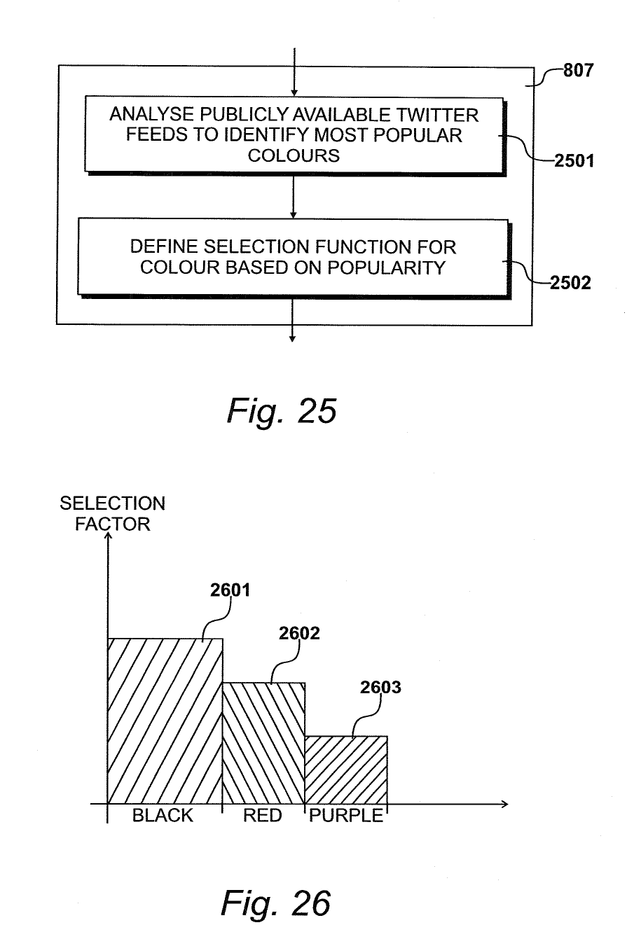

### FIG. 25

In an embodiment, an analysis for step 807 shown in FIG. 8 includes analysing publicly available data to define a selection function. This method is detailed in FIG. 25. At 2501 publicly available Twitter™ feeds are analysed to identify the most popular three colours over the past month. At step 2502 a selection function for a colour attribute is defined based on popularity.

### FIG. 26

A histogram resulting from the analysis described by the steps of FIG. 25 is shown in FIG. 26. The colour black 2601 has the highest popularity, followed by red 2602 and purple 2603. The levels of these selection factors have been determined automatically by an analysis of the publicly available data on Twitter.

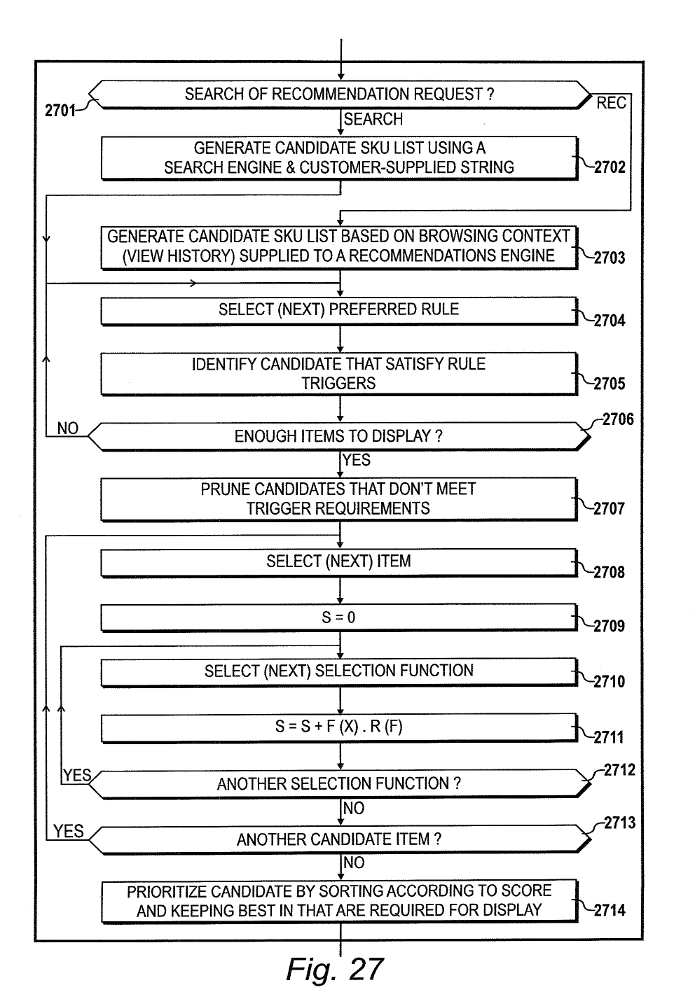

### FIG. 27

The definition of selection processes is applied at step 708 in FIG. 7 while a customer is browsing one of the e-commerce sites 107 to 109. Step 708 is detailed in FIG. 27. At step 2701 a question is asked as to whether a search or recommendation request has been sent by the customer's browser 101. In the case of a search, control is directed to step 2702, where a candidate list of SKUs is generated by a search engine in response to a customer-supplied search string.

The search engine is implemented as part of the data processor 113 by a web server such as web server 201, operating on cached SKU data from the database server 206.

In the case of a recommendation request, control is directed to step 2703, where a candidate list of SKUs is generated by a recommendations engine in response to browsing context, such as recent history of items viewed. The recommendations engine is also implemented as part of the data processor 113 in a similar manner to the search engine, but using a recommendations process instead of a search process. The search engine and recommendations engine instructions are part of the priority processing instructions 502.

On a first iteration, at step 2704 the first preferred rule 509 is selected, and at step 2705 candidates are identified that satisfy rule triggers 2203. At step 2706 a question is asked as to whether there are enough items to satisfy display requirements for the web page. Typically, at least three items must be provided for display, and this number may vary according to the design and proportions of the web page. If there are not enough items for display, control is directed back to step 2704, where the next preferred rule 510 is selected.

This process repeats until a rule has been identified whose triggers result in sufficient items for display requirements. At step 2707 a rule has been identified, and the candidate items that don't satisfy the rule triggers are pruned from the set of candidate items. It will be appreciated that this initial process is relatively computationally efficient, and reduces the number of candidates for which more intensive numerical processing will later be performed, thereby resulting in a speedy update of items on the customer's browser 101.

At step 2708 the first item in the pruned list of candidate items is selected. At step 2709 a score value for the item, S, is set to zero. At step 2710 the first selection function 601 for the item 504 is selected. At step 2711 the score is incremented according to the product of the selection function 602 of the attribute and the attribute factor 2103 of the rule 509. At step 2712 a question is asked as to whether there is another selection function to be considered. If so, control is directed to step 2710 and the score is incremented again.

Alternatively, once all selection functions have been considered, the score calculation for the item is complete. At step 2713 a question is asked as to whether other candidate items require there scores to be calculated. If so, control is directed back to step 2708. Alternatively, if all candidate item scores have been calculated, control is directed to step 2714. At step 2714, scored candidates are prioritised by sorting according to their score, and identifying the top N best scorers, where N is the number of items required to be displayed. This completes the process 708 of generating a prioritised list of items.

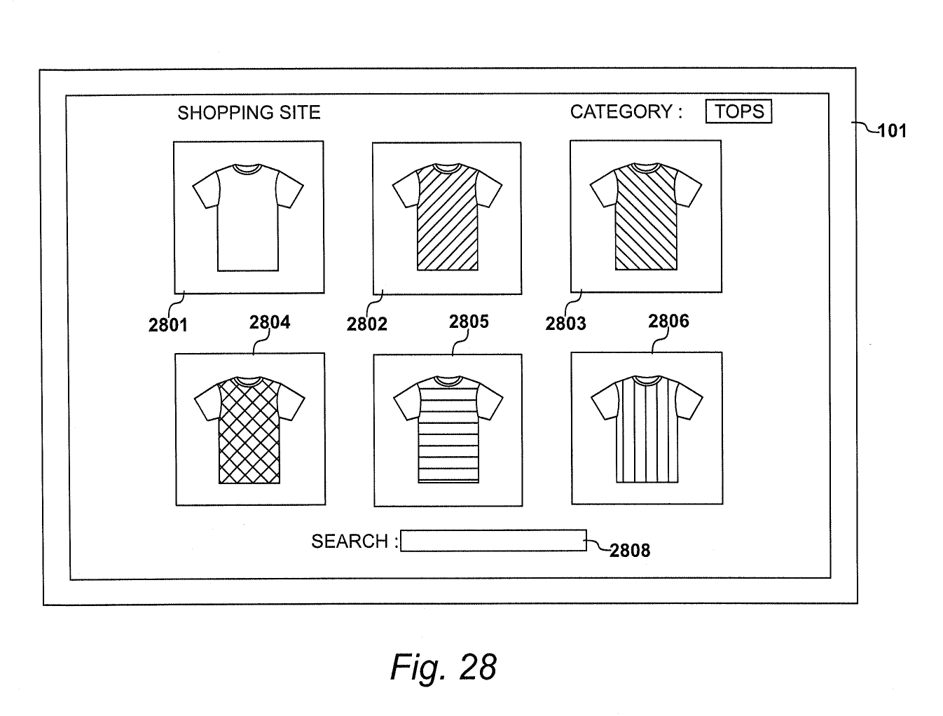

### FIG. 28

The prioritized list of items are then supplied to the customer's web browser 101 at step 709 in FIG. 7. The resulting display is illustrated in FIG. 28. Two rows of garment images 2801 to 2806 are displayed, representing the items that have been prioritized by an expert at the supplier 110. A category field 2807 and a search field 2808 are also provided to the customer, to continue navigating the web site. Alternatively, by selecting one of the displayed items 2801 to 2806, a purchase may be made.

1. A method of defining a selection process for items provided by an e-commerce site to shoppers' web browsers, comprising steps of:
a) identifying at least one selection attribute for each said e-commerce shop item;
b) defining a selection function in association with each said selection attribute;
c) defining at least one rule for combining at least one selection score from respective said selection functions to obtain an item score; and
d) defining the selection process as selecting items in response to said item scores.

2. The method of claim 1, wherein said step c) further includes defining at least one trigger for each said rule, to the effect that a rule will only be applied when trigger conditions thereof are met.

3. The method of claim 1, wherein said selection process includes validating each rule in a prioritized list of rules, until a rule is identified as meeting at least one rule requirement.

4. The method of claim 1, wherein said step b) of defining a selection function is performed in response to a manipulation of a graphical user interface.

5. The method of claim 1, wherein said step b) of defining a selection function is performed automatically in response to an analysis of e-commerce data.

6. The method of claim 1, wherein said step b) of defining a selection function is performed automatically in response to an analysis of publicly available data.

7. The method of claim 1, wherein said step a) includes identifying a discontinuous selection attribute.

8. A method of selecting items to be provided by an e-commerce site for display on shoppers' web browsers, comprising steps applied to candidate items of:
a) identifying at least one selection attribute for each said candidate item;
b) evaluating a selection function associated with each said selection attribute to obtain a selection score;
c) applying a rule for combining a plurality of selection scores to obtain an item score for each respective item; and
d) selecting preferred items in response to said item scores.

9. The method of claim 8, wherein said method includes validating at least one of a plurality of rules in a prioritized list of rules, until a rule is identified as meeting at least one requirement of its applicability.

10. The method of claim 8, wherein said step c) further includes processing at least one trigger for each said rule, to the effect that a rule will only be applied when trigger conditions thereof are met.

11. The method of claim 8, wherein said step a) includes identifying an analysis of tracking history as a selection attribute.

12. The method of claim 8, wherein said step a) includes identifying an analysis of publicly available data as a selection attribute.

13. The method of claim 8, wherein said step a) includes identifying an analysis of sales data as a selection attribute.

14. The method of claim 8, wherein said step a) includes identifying a user's geographical location as a selection attribute.

15. The method of claim 8, wherein said step a) includes identifying a discontinuous selection attribute.

16. The method of claim 8, wherein said candidate items are identified by a search engine.

17. The method of claim 8, wherein said candidate items are identified by a recommendations engine.

18. A method of defining a selection process for shop items provided by an e-commerce site to shoppers' web browsers, comprising steps performed on a graphical user interface of:
a) identifying at least one selection attribute for each said e-commerce shop item;
b) defining a selection function in association with each said selection attribute;
c) defining at least one rule for combining selection scores from respective said selection functions to obtain an item score.
